(19) United States
(12) Patent Application Publication
(10) Pub. No.: US 2010/0131323 A1
(43) Pub. Date: May 27, 2010

(54) TIME MANAGEMENT METHOD AND SYSTEM

(75) Inventors: Sara H. Basson, White Plains, NY (US); Dimitri Kanevsky, Ossining, NY (US); Edward Emile Kelley, Wappingers Falls, NY (US); Irina Rish, Rye Brook, NY (US)

Correspondence Address: Law Offices of Ira D. Blecker, P.C., 206 Kingwood Park, Poughkeepsie, NY, 12601, US

(73) Assignee: INTERNATIONAL BUSINESS MACHINES CORPORATION, Armonk, NY (US)

(21) Appl. No.: 12/277,615

(22) Filed: Nov. 25, 2008

(51) Int. Cl. G06Q 10/00

(52) U.S. Cl. 705/8

(57) ABSTRACT

Disclosed is a time management method which includes detecting a current activity of a user on a computer, classifying the current activity according to a predetermined characteristic, prioritizing the current activity according to a predetermined order of importance, and prompting the user to work on the highest important activity if not already working on it. Also disclosed is a computer readable storage medium storing instructions that, when executed by a computer, causes the computer to perform a method of time management, a computer program product and a system for time management.

### BACKGROUND OF THE INVENTION

The present invention relates to the field of methods for monitoring and tracking the activities engaged in by a user of a computer and more particularly relates to the field of methods for monitoring and tracking activities by the computer user wherein the activities can be prioritized and learned by the computer.

Computers have become almost universal in the office work environment. Most employees use a computer daily in their work to accomplish the majority of their tasks. In addition to performing work functions, computers are used to facilitate communication and scheduling in the modern office environment. Employees in a typical office use their computers for word-processing, accounting, e-mail, scheduling, Internet and a multitude of applications specific to their jobs.

The network architecture, operating system and specific application programs in a particular office can vary widely; however, almost all workplace environments involve a network of personal computers running a basic set of e-mail, Internet, scheduling, spread-sheet and word-processing computer programs. In addition, specific employees may have accounting software, programming software, graphic design software or other job-specific software. The operating systems in use today permit multi-tasking, which allows users to operate several different application programs at once on a single computer and to easily switch between application programs.

Accordingly, in a computerized office environment, employees can engage in a number of different tasks on their computers. Employees can also use their computers to perform specific tasks for a number of different projects, clients or administrative duties. For instance, an employee may use his or her word-processing software to develop documents for a number of distinct projects. One can characterize the use of different computer programs or the use of a computer program for different projects or functions as distinct “activities” of the user. For a variety of reasons, it can be advantageous for an organization to track a computer-user's activities.

The user's activities can be tracked in connection with a number of variables, the most important of which is likely time. By tracking time in connection with a user's activities on a computer, one can monitor how much time is spent on particular activities. This can be essential information for project management, project assessments, efficiency analysis, billing and organizational management. A user's activities can also be tracked in connection with other variables such as network or processor loading.

While computers in a computerized office environment are undoubtedly intended primarily for work-related purposes, there is the opportunity for computer users to become distracted and instead use the computers for non-work-related purposes, such as computer games, shopping and in general “surfing” the internet

Internet activity can be monitored to determine which internet sites a computer user is using and computers can be monitored to determine which software is activated. However, this provides only a crude assessment of how a computer user's time is being spent. There is also no formal way to identify whether the distribution of time across activities is the appropriate one.

Current tools attempt to promote productivity by requiring the computer user to be organized. For example, “To-Do” list programs allow users to schedule activities and be reminded of them when they are due. Similarly, the “History” function of web browsers is also a useful tool for determining productivity because computer users can track their activities online. However, neither of these tools assist the computer user to stay focused on work-related tasks.

There have been various solutions proposed for the tracking of computer users' time.

Lowell U.S. Pat. No. 6,381,632, the disclosure of which is incorporated by reference herein, discloses a method of monitoring network usage by a computer or a similar device.

Bunch U.S. Pat. No. 6,795,856, the disclosure of which is incorporated by reference herein, discloses a system for monitoring internet access by employees and identifies websites that employees visit and the amount of time employees spend at each website.

Hegli et al. U.S. Pat. No. 6,947,985, the disclosure of which is incorporated by reference herein, discloses a method for managing internet access by a group of internet users which categorizes uses of the internet and restricts access by type of user, network load and time of day.

Richardson et al. U.S. Pat. No. 7,069,229, the disclosure of which is incorporated by reference herein, discloses a method for tracking an employee's progress on multiple tasks and estimates how well an employee can estimate the time it takes to complete the task.

Mathew et al. U.S. Pat. No. 7,302,488, the disclosure of which is incorporated by reference herein, discloses a method for parental control of internet access and customization of such parental control.

Bannerjee et al. U.S. Pat. No. 7,321,931, the disclosure of which is incorporated by reference herein, discloses a method for time-controlled access to a network where time spent at a particular website or time spent at multiple websites is controlled.

Goykhman U.S. Patent Application Publication 2002/0174134, the disclosure of which is incorporated by reference herein, discloses a method which monitors and tracks the time spent on each activity by a user. Activity identifiers are preloaded from a database but may be manually changed by a user.

Searl et al. U.S. Patent Application Publication 2004/0230530, the disclosure of which is incorporated by reference herein, discloses a method of monitoring transaction activities on networks to detect breaches in transaction use.

Huang U.S. Patent Application Publication 2006/0190725, the disclosure of which is incorporated by reference herein, discloses a method which monitors activities with respect to files, etc. and records system's activities and user's activities. The manager and user define the scope of the projects in which project-related computer activities will be recorded and productivity attributes will be derived.

It would be desirable to have a computer tool that would assist the computer user to prioritize his/her tasks while also staying focused.

### BRIEF SUMMARY OF THE INVENTION

The various advantages and purposes of the present invention as described above and hereafter are achieved by providing, according to a first aspect of the invention, a time management method comprising the steps of:

detecting a current activity of a user on a computer;

classifying the current activity according to a predetermined characteristic;

prioritizing the current activity according to a predetermined order of importance; and

prompting the user to work on the highest important activity if not already working on it.

According to a second aspect of the invention, there is provided a computer readable storage medium storing instructions that, when executed by a computer, causes the computer to perform a method of time management, the method comprising the steps of:

detecting a current activity of a user on a computer;

classifying the current activity according to a predetermined characteristic;

prioritizing the current activity according to a predetermined order of importance; and

prompting the user to work on the highest important activity if not already working on it.

According to a third aspect of the invention, there is provided a computer program product comprising:

a computer usable medium having computer readable program code means embodied therein for a time management method, the computer readable program code means in the computer program product comprising:

computer readable program code means for causing a computer to detect a current activity of a user on a computer;

computer readable program code means for causing a computer to classify the current activity according to a predetermined characteristic;

computer readable program code means for causing a computer to prioritize the current activity according to a predetermined order of importance; and

computer readable program code means for causing a computer to prompt the user to work on the highest important activity if not already working on it.

According to a fourth aspect of the invention, there is provided a system for time management comprising:

a module for detecting a current activity of a user on a computer;

a module for classifying the current activity according to a predetermined characteristic;

a module for prioritizing the current activity according to a predetermined order of importance; and

a module for prompting the user to work on the highest important activity if not already working on it.

### BRIEF DESCRIPTION OF THE DRAWINGS

The features of the invention believed to be novel and the elements characteristic of the invention are set forth with particularity in the appended claims. The Figures are for illustration purposes only and are not drawn to scale. The invention itself, however, both as to organization and method of operation, may best be understood by reference to the detailed description which follows taken in conjunction with the accompanying drawings in which:

FIG. 1 is a block diagram that illustrates one exemplary hardware environment of the present invention.

FIG. 2 is a flow chart illustrating the process of the present invention.

FIG. 3 is a flow chart illustrating the adaptive learning aspect of the present invention.

FIG. 4 is a flow chart illustrating the process of training a predictor used in the present invention.

### DETAILED DESCRIPTION OF THE INVENTION

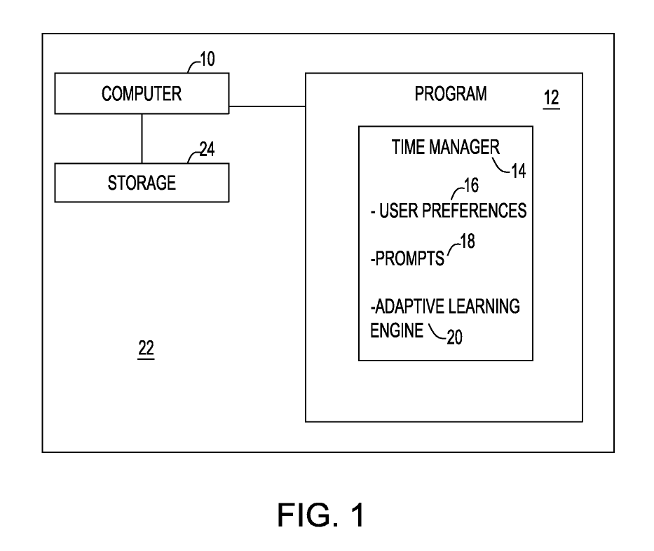

The program environment in which a present embodiment of the invention is executed illustratively incorporates a general-purpose computer or a special purpose device such as a hand-held computer. FIG. 1 is a block diagram that illustrates one exemplary hardware environment of the present invention. The present invention is typically implemented using a computer system 22 comprising computer 10 comprised of microprocessor means, random access memory (RAM), read-only memory (ROM) and other components. The computer may be a personal computer, mainframe computer or other computing device. Resident in the computer 10, or peripheral to it, will be a storage device 24 of some type such as a hard disk drive, floppy disk drive, CD-ROM drive, tape drive or other storage device.

Generally speaking, the software implementation of the present invention, program 12 in FIG. 1, is tangibly embodied in a computer-readable medium such as one of the storage devices 14 mentioned above. The program 12 comprises instructions which, when read and executed by the microprocessor of the computer 10 causes the computer 10 to perform the steps necessary to execute the steps or elements of the present invention.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

The present invention is directed to a time management method for a computer user which enables the computer user to make more efficient use of his/her time. That is, the computer system 22 would monitor a computer user's activities and when the computer user becomes distracted and leaves higher importance activities for lower importance activities for a predetermined amount of time, the computer system 22 can prompt the computer user to return to the higher importance activities.

The present time management method can be a management tool to monitor the activities of a computer user employee and to provide positive feedback to the computer user employee. However, the present inventors believe that a more important use of the present time management method is as a “self-help” tool for the computer user employee to provide real-time feedback and to keep the computer user employee focused on the more important tasks. That is, whenever the computer user employee gets distracted, the time management method prompts the computer user employee to refocus on the more important tasks. If the computer user employee has been productive, then the time management method may reward the computer user employee with a relaxation period of non-work-related activities.

Referring back to FIG. 1, it can be seen that the program 12 comprises a time manager 14 which monitors the activities of a computer user. The time manager 14 includes user preferences 16, prompts 18 and in a preferred embodiment an adaptive learning engine 20. The time manager 14 monitors the activities of a computer user and detects when the computer user is spending time on work-related and non-work-related activities. The categorization of the activities into work-related and non-work-related activities is enabled by the user preferences 16 which are selected by the computer user. For example, the computer user could indicate in the user preferences 16 that working on a spreadsheet program would be classified as a work-related activity while doing internet shopping would be classified as a non-work-related activity.

In order for the computer system 22 to know which activities fall into which category, the computer user would have to specifically include in the user preferences details of the computer activity. For example, if the computer user is working a spreadsheet program, the computer user would have to list certain details in the user preferences 16 about the spreadsheet program such as its name and function so that the computer would know when the computer user is working on the spreadsheet program. Too, working on a spreadsheet program would have to be listed in the user preferences 16 as a work-related activity. As another example, if the computer user is using the internet to visit a shopping website, the computer user would have to list the URL of the website and classify it as a non-work-related activity.

Populating the user preferences 16 with the details of every activity and every website visited would be extremely onerous. Accordingly, in one preferred embodiment of the present invention, the present inventors propose an adaptive learning engine 20 which would learn activities and websites based on keywords entered by the computer user. In this way, the adaptive learning engine 20 could learn the computer's user's preferences and then each new activity could be classified as it is encountered by the adaptive learning engine 20.

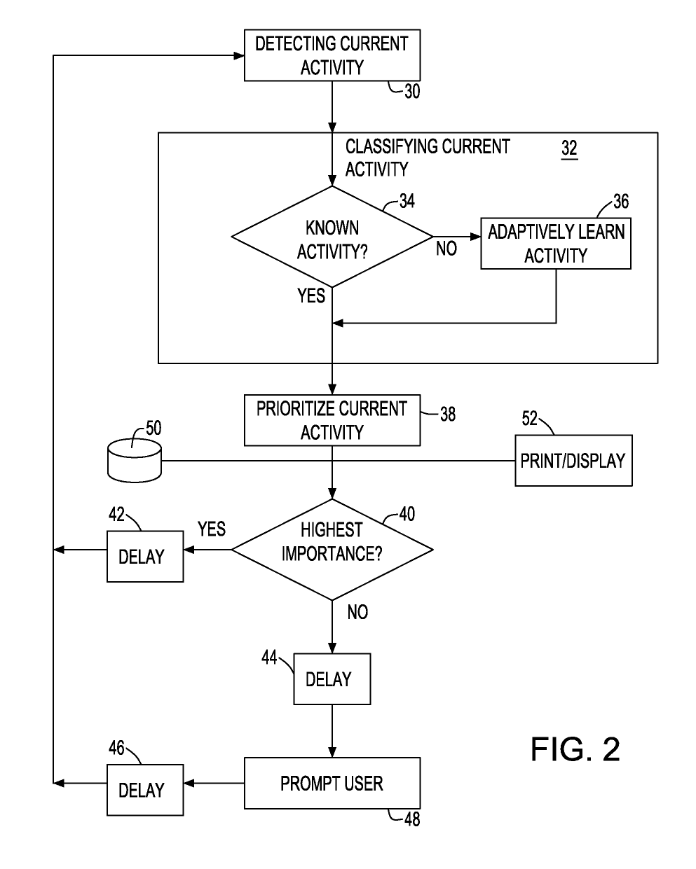

Turning now to FIG. 2, the methodology of the present invention will be described. In the first step of the method, there is detecting the current activity 30 of the computer user. This step is accomplished by conventional means and merely registers the activity of the computer user. Using the previous examples, the time manager 14 will register the activity of the computer user as a spreadsheet program or an internet website. Details of the spreadsheet program and internet website may also be registered if desired.

Next, the time manager 14 engages in classifying the current activity 32 according to a particular characteristic pre-programmed into the user preferences 16 of the time manager 14. The particular characteristic could be whether the activity is work-related or non-work-related. The particular characteristic could also be completion date. For example, if there are two work-related activities having different completion dates, the time manager 14 could classify the work-related activities by completion date. As another example, those activities having no completion date, such as recreational activity, could be defaulted into a long term completion date and thus of lower importance. The particular characteristic could also be work-related versus relaxation activity versus time-wasting activity. A relaxation activity could be something like learning a new language while a time-wasting activity could be something like internet gaming or internet shopping.

How the time manager 14 determines the classification of the particular activity will now be discussed. As shown in step 34, the time manager 14 first evaluates the activity to see if it is a known activity that has been previously classified. If the particular activity is unfamiliar to the time manager 14, the time manager 14 could simply pause and allow the computer user to manually classify the activity. This in itself is time consuming. A better solution is, in a preferred embodiment, to include an adaptive learning engine 20 (shown in FIG. 1). Thus, in one preferred embodiment of the process flow, after it is determined in step 34 that the activity is not a known activity, the process flow diverts to adaptively learn the unknown activity as shown in step 36. Based on prior activities, keywords programmed into the adaptive learning engine 20 and the user preferences 16 (shown in FIG. 1), the adaptive learning engine 20 learns the current activity and classifies it according to the particular characteristic desired, for example, work-related or non-work-related.

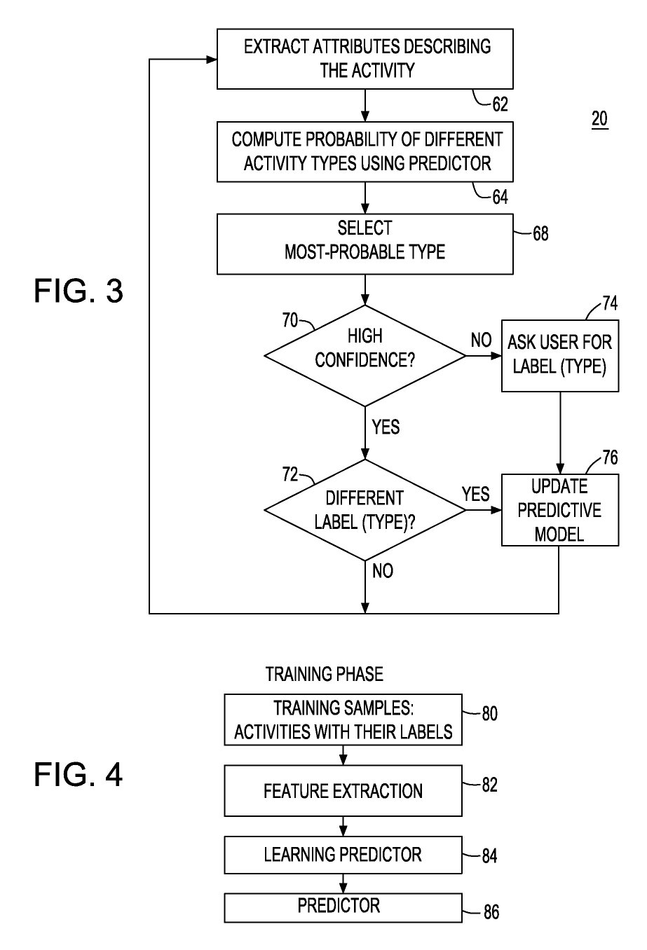

Referring now to FIG. 3, the adaptive learning engine 20 will be discussed in detail. The adaptive learning engine extracts attributes describing the activity (block 62), which has already occurred in step 30 of FIG. 2, and computes probability of different activity types using a predictor (block 64).

The process of determining the predictor is discussed with reference to FIG. 4. Prior to using the predictor with test data, there must first be a training phase. In the training phase, the adaptive learning engine 20 takes as an input a set of training samples (block 80), such as examples of past activities of a user, with the associated labels such as work-related versus non-work-related. The adaptive learning engine 20 uses a feature extractor component first (block 82), to extract a description of an activity in terms of its features, or attributes, such as, for example, a list of words and a list of links occurring on a web page the computer user is currently

Data mining algorithms are suitable for use as a predictor in the present invention. Particular types of data mining algorithms are called probabilistic predictors, one example being, for purposes of illustration and not limitation, the Naïve Bayes probabilistic predictor.

Returning to FIG. 3, with the use of the predictor, the most probable activity type is selected (block 68). The choice of activity selected may have a high confidence level or low confidence level (block 70). If the activity selected has high confidence, then the adaptive learning engine asks the computer user if the activity selected is of a different label type, i.e., the adaptive learning engine chose the wrong label type. If the answer to this question is no, meaning the right label type for the activity has been selected and the process as shown in FIG. 2 would continue. If the answer to this question is yes, the right label is selected and the predictive model is updated (block 76). Then, the process as shown in FIG. 2 would continue.

Referring back to the confidence level (block 70), if there is low confidence, then the computer user is asked for the label type of the activity (block 74) and then the predictive model is update (block 76). The process would then continue as shown in FIG. 2.

Returning now to FIG. 2, there is also the opportunity for the computer user to manually flag a non-work-related activity as a work-related activity. For example, the computer user may be asked to research restaurants on the internet for a client's visit. Normally, such internet surfing would be classified as non-work-related activity but the computer user may manually flag it as work-related.

If the current activity is a known activity, the process flow proceeds to the next step of prioritizing the current activity.

The next step of the process flow is prioritizing the current activity according to a predetermined order of importance, step 38. For example, if the time manager 14 is programmed in its user preferences 16 that work-related activities have a higher order of importance than non-work-related activities, then if the computer user is working on a non-work-related activity such as gaming or internet shopping, this type of activity would be classified as a lower order of importance. The priority of an activity depends on the current situation. For example, an urgent work-related task would usually have high priority but it can be changed if another task arrives with higher priority. The time manager 14 is also more sophisticated in that it can be programmed to allow a period of non-work-related activities after a period of work-related activities in order to promote the productivity of the computer user. The time manager 14 may also be programmed to switch priorities of activities on a frequent basis to keep computer users from being distracted.

After prioritizing, the time manager notes, in step 40, if the current activity is of the highest importance. If the current activity is of the highest importance as determined by the user preferences 16, then the process proceeds back to detecting the current activity, step 30. It may be desirable to insert a delay, step 42, so that the time manager 14 is not unduly tying up system resources by continually detecting the current activity. The delay may be set, for example, from 1 to 30 minutes (or even longer if desired) so that the activities of the computer user are detected frequently but not continuously.

If the time manager 14 notes that the current activity of the computer user is of lower importance, the time manager 14 may prompt the computer user to refocus onto more important activities, as shown in step 48. The prompting would be by a message displayed on the computer user's screen. The message could be very simple such as “Please return to work-related task”. Alternatively, the message could be contextual such as “Please leave your computer gaming for the important work-related task which is due tomorrow”. If desired, there could be a delay inserted, such as at step 44, before prompting to give the computer user time to refocus on his/her own. Also, once the computer user has been prompted at step 48 to return to work-related tasks, a delay step 46 could be inserted before detecting the current activity in step 30. The delay 46 again would be useful so that the time manager 14 does not unduly tie up system resources. The delay may be set, for example, from 1 to 30 minutes (or even longer if desired).

It may be desirable to store the current activity at some point in the process, such as after classifying, so that the computer user can check back over time to review his/her productivity. As shown in FIG. 2, the current activity is stored, preferably on local storage 24 (FIG. 1), as shown in step 48, so that the computer user can call up his/her activity history at any time. The current activity should be able to be printed or displayed to the computer user as indicated by step 50.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

1. A time management method comprising the steps of:
detecting a current activity of a user on a computer;
classifying the current activity according to a predetermined characteristic;
prioritizing the current activity according to a predetermined order of importance; and
prompting the user to work on the highest important activity if not already working on it.

2. The time management method of claim 1 wherein the step of classifying comprising adaptively learning types of activities and preferences of the user for working on an activity.

3. The time management method of claim 1 wherein the predetermined characteristic in the step of classifying is work-related and nonwork-related activities.

4. The time management method of claim 3 wherein the nonwork-related activities are further classified as relaxation activities and time-wasting activities.

5. The time management method of claim 3 wherein the work-related activities are further classified by required date of completion.

6. The time management method of claim 1 wherein the predetermined order of importance in the step of prioritizing is a work-related activity has a higher importance than a non-work-related activity.

7. The time management method of claim 2 wherein adaptively learning comprises applying a data mining algorithm to an activity to determine whether the activity is a work-related activity or a non-work-related activity.

8. The time management method of claim 1 further comprising the step after prioritizing of delaying for a predetermined amount of time prior to prompting the user.

9. A computer readable storage medium storing instructions that, when executed by a computer, causes the computer to perform a method of time management, the method comprising the steps of:
detecting a current activity of a user on a computer;
classifying the current activity according to a predetermined characteristic;
prioritizing the current activity according to a predetermined order of importance; and
prompting the user to work on the highest important activity if not already working on it.

10. The computer readable storage medium of claim 9 wherein the step of classifying comprising adaptively learning types of activities and preferences of the user for working on an activity.

11. The computer readable storage medium of claim 9 wherein the predetermined characteristic in the step of classifying is work-related and nonwork-related activities.

12. The computer readable storage medium of claim 9 wherein the predetermined order of importance in the step of prioritizing is a work-related activity has a higher importance than a non-work-related activity.

13. The computer readable storage medium of claim 10 wherein adaptively learning comprises applying a data mining algorithm to an activity to determine whether the activity is a work-related activity or a non-work-related activity.

14. A computer program product comprising:
a computer usable medium having computer readable program code means embodied therein for a time management method, the computer readable program code means in the computer program product comprising:
computer readable program code means for causing a computer to detect a current activity of a user on a computer;
computer readable program code means for causing a computer to classify the current activity according to a predetermined characteristic;
computer readable program code means for causing a computer to prioritize the current activity according to a predetermined order of importance; and
computer readable program code means for causing a computer to prompt the user to work on the highest important activity if not already working on it.

15. The computer program product of claim 14 wherein the computer readable program code means for causing a computer to classify comprising computer readable program code means for causing a computer to adaptively learn types of activities and preferences of the user for working on an activity.

16. The computer readable storage medium of claim 14 wherein the predetermined characteristic is work-related and nonwork-related activities.

17. The computer readable storage medium of claim 14 wherein the predetermined order of importance is a work-related activity has a higher importance than a non-work-related activity.

18. The computer readable storage medium of claim 15 wherein the computer readable program code means for causing a computer to adaptively learn comprises the application of a data mining algorithm to an activity to determine whether the activity is a work-related activity or a non-work-related activity.

19. A system for time management comprising:
a module for detecting a current activity of a user on a computer;
a module for classifying the current activity according to a predetermined characteristic;
a module for prioritizing the current activity according to a predetermined order of importance; and
a module for prompting the user to work on the highest important activity if not already working on it.

20. The system of claim 19 wherein the module for classifying further comprising a module for adaptively learning types of activities and preferences of the user for working on an activity.
